(19) United States
(12) Patent Application Publication
(10) Pub. No.: US 2025/0145788 A1
(43) Pub. Date: May 8, 2025

(54) VISCOELASTIC POLYURETHANE FOAM WITH POLYURETHANE GEL COATING

(71) Applicant: Dow Global Technologies LLC, Midland, MI (US)

(72) Inventors: Qinghao Meng, Angleton, TX (US); Meagan Broadway, Freeport, TX (US); Jacob W. Strother, Freeport, TX (US); David J. Honkomp, Marietta, GA (US)

(21) Appl. No.: 18/838,049

(22) PCT Filed: Apr. 27, 2023
(86) PCT No.: PCT/US2023/066272

§ 371 Date: Aug. 13, 2024

Related U.S. Application Data
(60) Provisional application No. 63/335,744, filed on Apr. 28, 2022.

(51) Int. Cl. C08J 9/36; C08G 18/08; C08G 18/10; C08G 18/48; C08G 101/00

(52) U.S. Cl. CPC C08J 9/365; C08G 18/10; C08G 18/14; C08G 18/4816; C08G 2101/00; C08G 2110/0008; C08J 2375/08

(57) ABSTRACT

Embodiments relate to a coated viscoelastic polyurethane foam. The viscoelastic polyurethane foam is a reaction product of a first isocyanate component that includes a polyisocyanate and a first isocyanate reactive component that includes at least one polyoxyethylene-polyoxypropylene polyether polyol and at least one polyoxypropylene polyether polyol. The coated material is reaction product of a second isocyanate component that includes an isocyanate-terminated prepolymer and a second isocyanate reactive component that includes at least one polyoxypropylene-polyoxyethylene polyether polyol and at least one acetylated ester based plasticizer.

### FIELD

Embodiments relate to a coated viscoelastic polyurethane foam and a method of preparing the coated viscoelastic polyurethane foam.

### INTRODUCTION

Flexible, viscoelastic polyurethane foam (also known as slow-recovery foam, memory foam, and high-damping foam) is characterized by relatively slow, gradual recovery from compression and the viscoelastic foam may have a relatively lower resiliency. The viscoelastic polyurethane foam may be useful in comfort applications such as bedding and pillows.

Coatings for foams, such as viscoelastic foams, are proposed to minimize, reduce, and/or avoid issues as related to warm sleep (also called “sleeping hot” or “hot sleep”) that may result, in part, from a lack of sufficient thermal and/or moisture transfer from the human body to the environment. For example, warm sleep may be, in part, result from a blanket on top of the human body and/or from the mattress underneath the human body. Polyurethane gel layers coated on polyurethane based foam pillows have been suggested, e.g., due to the greater solid mass and contact area (“heat sink effect”) such gel layers may provide compared with the foam itself (which foam may be mostly air). However, improvements are sought with respect to adhesion between the gel layer and the foam layer.

### SUMMARY

Embodiments may be realized by providing a coated viscoelastic polyurethane foam that includes a viscoelastic polyurethane foam and a coating material on the viscoelastic polyurethane foam. The viscoelastic polyurethane foam is a reaction product of a first isocyanate component and a first isocyanate reactive component, the first isocyanate component including at least one polyisocyanate, and the first isocyanate reactive component having a first polyol component including: (i) from 60 wt % to 90 wt % of at least one polyoxyethylene-polyoxypropylene polyether polyol based on a total weight of the first polyol component, the at least one polyoxyethylene-polyoxypropylene polyether polyol having an ethylene oxide content of at least 50% based on a total alkylene oxide content of the at least one polyoxyethylene-polyoxypropylene polyether polyol, a nominal hydroxyl functionality from 2 to 4, a hydroxyl number from 25 mg KOH/g to 45 mg KOH/g, and a primary hydroxyl content of at least 40% based on a total hydroxyl content of the at least one polyoxyethylene-polyoxypropylene polyether polyol, and (ii) from 10 wt % to 40 wt % of at least one polyoxypropylene polyether polyol based on the total weight of the first polyol component, the at least one polyoxypropylene polyether polyol having a nominal hydroxyl functionality from 2 to 4 and a hydroxyl number from 40 mg KOH/g to 200 mg KOH/g. The coating material is a reaction product of a second isocyanate component and a second isocyanate reactive component, the second isocyanate component including at least one isocyanate-terminated prepolymer, and the second isocyanate reactive component including: (iii) from 30 wt % to 49 wt % of at least one polyoxypropylene-polyoxyethylene polyether polyol based on a total weight of the second isocyanate reactive component, the at least one polyoxypropylene-polyoxyethylene polyether polyol having an ethylene oxide content from 10% to 30% based on a total alkylene oxide content of the at least one polyoxypropylene-polyoxyethylene polyether polyol, a nominal hydroxyl functionality from 2 to 4, a hydroxyl number from 20 mg KOH/g to 40 mg KOH/g, and a primary hydroxyl content of at least 40% based on a total hydroxyl content of the at least one polyoxypropylene-polyoxyethylene polyether polyol, and (iv) from 51 wt % to 70 wt % of at least one acetylated ester based plasticizer based on a total weight of the second isocyanate reactive component.

### DETAILED DESCRIPTION

Embodiments relate to a coated viscoelastic polyurethane foam, which viscoelastic foam may be characterized as having a low resiliency. Such as the resiliency may be less than or equal to 20% as measured according to ASTM D 3574 (may also be referred to as a Ball Rebound Test). The resiliency may be greater than 1%. The viscoelastic polyurethane foam is a reaction product of an isocyanate component and an isocyanate-reactive component. The coating material is a reaction product of another isocyanate component and another isocyanate-reactive component. The isocyanate components include at least one compound having an isocyanate group. The isocyanate-reactive components include at least one compound having an isocyanate reactive hydrogen atom group, such as a hydroxyl group and/or an amine group. For example, the isocyanate-reactive components may include at least one polyether polyol that is the reaction product of alkylene oxides (such as at least one ethylene oxide, propylene oxide, and/or butylene oxide) with initiators containing from 2 to 8 active hydrogen atoms per molecule. The isocyanate components and/or the isocyanate-reactive components may include at least one additive such a catalyst, a curing agent, a surfactant, a plasticizer, a blowing agent, a pigment, a fragrance, a flame retardant, a smoke suppressant, a demolding agent, an antioxidant, a UV stabilizer, water, filler, and/or other additives known in the art.

The viscoelastic polyurethane foam may be prepared at an isocyanate index from 40 to 150 (e.g., from 40 to 100, from 40 to 80, from 40 to 60, etc.) The coating material may be prepared at an isocyanate index from 60 to 90 (e.g., from 60 to 80, from 70 to 80, from 70 to 75, etc.) The isocyanate index is defined as the molar stoichiometric excess of isocyanate moieties in a reaction mixture with respect to the number of moles of isocyanate-reactive units (active hydrogens available for reaction with the isocyanate moiety), multiplied by 100. An isocyanate index of 100 means that there is no stoichiometric excess, such that there is 1.0 mole of isocyanate groups per 1.0 mole of isocyanate-reactive groups, multiplied by 100.

The coating material and the viscoelastic foam may be on, e.g., directly on, each other. The coating material may be a preformed coating material and the viscoelastic polyurethane foam may be formed on (e.g., directly on) the preformed coating material. For example, the preformed coating material may be provided in a mold and the viscoelastic polyurethane foam formed on (e.g., directly on) the preformed coating material in the mold. In another embodiment, the viscoelastic polyurethane foam may be formed in a mold and the coating material applied on the preformed viscoelastic polyurethane foam.

### Viscoelastic Foam Material

The viscoelastic polyurethane foam may be prepared in a slabstock process (e.g., as free rise foam), a molding process (such as in a box foaming process), or any other process known in the art. The viscoelastic polyurethane foam may be prepared at initial ambient conditions (i.e., room temperature ranging from 20° C. to 25° C. and standard atmospheric pressure of approximately 1 atm).

The viscoelastic polyurethane foam is a reaction product of a first isocyanate component and a first isocyanate reactive component.

The first isocyanate component includes at least one polyisocyanate. The polyisocyanate includes on average more than one isocyanate group per compound. The polyisocyanate may be aliphatic, cycloaliphatic, alicyclic, arylaliphatic, aromatic, and/or derivatives thereof. For example, the isocyanate component may include at least one aromatic polyisocyanate. The isocyanate component may include a toluene diisocyanate (TDI) based polyisocyanate and/or diphenyl methylene diisocyanate (MDI) based polyisocyanate. The first isocyanate component may exclude any isocyanate terminated prepolymers.

The first isocyanate reactive component includes a first polyol component that includes (e.g., consists essentially of) two different types of polyols, in particular at least one polyoxyethylene-polyoxypropylene polyether polyol and at least one polyoxypropylene polyether polyol. The first polyol component may include (e.g., consist essentially of) all the polyols in the first isocyanate-reactive component, which may further include a first additive component that includes at least additive such as blowing agents, catalysts, surfactants, etc.

The first polyol component includes from 60 wt % to 90 wt % (e.g., from 70 wt % to 90 wt %, from 75 wt % to 85 wt %, 78 wt % to 82 wt %, etc.) of at least one polyoxyethylene-polyoxypropylene polyether polyol based on a total weight of the first polyol component. By polyoxyethylene-polyoxypropylene polyether polyol it is meant a polyether polyol derived from a majority of ethylene oxide and a minority of propylene oxide. The at least one polyoxyethylene-polyoxypropylene polyether polyol has an ethylene oxide content of at least 50% (e.g., 55% to 95%, 60% 90%, 70% to 85%, 75% to 80%, etc.) based on a total alkylene oxide content of the at least one polyoxyethylene-polyoxypropylene polyether polyol (e.g., such that the total amount of ethylene oxide and propylene oxide is 100% and ethylene oxide content is total amount of ethylene oxide from that 100%). The at least one polyoxyethylene-polyoxypropylene polyether polyol has a nominal hydroxyl functionality from 2 to 4 (e.g., such as is a diol or triol). The at least one polyoxyethylene-polyoxypropylene polyether polyol has a hydroxyl number from 25 mg KOH/g to 45 mg KOH/g (e.g., from 30 mg KOH/g to 40 mg KOH/g). The at least one polyoxyethylene-polyoxypropylene polyether polyol a primary hydroxyl content of at least 40% (e.g., from 40% to 60%, from 40% to 50%, etc.) based on a total hydroxyl content of the at least one polyoxyethylene-polyoxypropylene polyether polyol (e.g., such that the total-OH group content is 100% and the primary hydroxyl group content is total amount of primary-OH groups vs. secondary-OH groups from that 100%).

The at least one polyoxyethylene-polyoxypropylene polyether polyol may include a first polyoxyethylene-polyoxypropylene polyether polyol and optionally a second polyoxyethylene-polyoxypropylene polyether polyol different from the first polyoxyethylene-polyoxypropylene polyether polyol, e.g., different by having a higher primary hydroxyl content. The first polyoxyethylene-polyoxypropylene polyether polyol may have the ethylene content from 70% to 85%, the primary hydroxyl content from 40% to 50%, and the hydroxyl number from 30 mg KOH/g to 40 mg KOH/g. The optional second polyoxyethylene-polyoxypropylene polyether polyol may have the ethylene content from 70% to 85%, the primary hydroxyl content from 75% to 85%, and the hydroxyl number from 30 mg KOH/g to 40 mg KOH/g.

Further, the first polyol component includes from 10 wt % to 40 wt % (e.g., 10 wt % to 30 wt %, 15 wt % to 25 wt %, etc.) of at least one polyoxypropylene polyether polyol based on the total weight of the first polyol component. By polyoxypropylene polyether polyol it is meant a homopolymer such that the polyether polyol is derived from propylene oxide. The at least one polyoxypropylene polyether polyol has a nominal hydroxyl functionality from 2 to 4 (e.g., is a diol or triol). The at least one polyoxypropylene polyether polyol has a hydroxyl number from 40 mg KOH/g to 200 mg KOH/g.

For example, the at least one polyoxypropylene polyether polyol may include a first polyoxypropylene polyether polyol that is a triol with a hydroxyl number from 100 mg KOH/g to 200 mg KOH/g (e.g., from 120 mg KOH/g to 180 mg KOH/g, from 140 mg KOH/g to 180 mg KOH/g, from 160 mg KOH/g to 170 mg KOH/g, etc.) The first polyoxypropylene polyether polyol may be present in an amount from 2 wt % to 15 wt % (e.g., 2 wt % to 10 wt %, 4 wt % to 6 wt %, etc.) based on a total weight of the first polyol component. The at least one polyoxypropylene polyether polyol may include a second polyoxypropylene polyether polyol that is a diol with a hydroxyl number from 40 mg KOH/g to 80 mg KOH/g (e.g., from 40 mg KOH/g to 60 mg KOH/g, from 50 mg KOH/g to 60 mg KOH/g, etc.) The second polyoxypropylene polyether polyol may be present in an amount from 8 wt % to 25 wt % (e.g., 10 wt % to 20 wt %, 14 wt % to 16 wt %, etc.) based on a total weight of the first polyol component.

The first additive component may be present in an amount from 1 wt % to 15 wt %, based on a total weight of the first isocyanate-reactive component. The first additive component may include water, e.g., from 2 wt % to 10 wt % of water based on a total weight of the first isocyanate-reactive component.

### Coating Material

The coating material, a polyurethane based gel coating, may be prepared in a molding process (such as in a box foaming process) or any other process known in the art. The coating layer may be prepared at ambient conditions (i.e., room temperature ranging from 20° C. to 25° C. and standard atmospheric pressure of approximately 1 atm).

The coating material is a reaction product of a second isocyanate component and a second isocyanate reactive component that includes a high loading of the acetylated ester based plasticizer.

The second isocyanate component includes at least one isocyanate terminated prepolymer. The at least one isocyanate terminated prepolymer may have a free NCO group content from 2% to 10% e.g., 3% to 7%, etc.) The at least isocyanate terminated prepolymer may be derived from an aromatic polyisocyanate and a polyether polyol, e.g., using processes known in the art. For example, the isocyanate terminated prepolymer is the reaction provide of a first polyisocyanate (e.g., aromatic polyisocyanate) and a first polyoxypropylene polyether polyol having a nominal hydroxyl functionality from 2 to 4 and a hydroxyl number from 45 mg KOH/g to 65 mg KOH/g. The polyisocyanate may include a toluene diisocyanate (TDI) based polyisocyanate and/or diphenyl methylene diisocyanate (MDI) based polyisocyanate.

The second isocyanate reactive component includes at least one polyether polyol and at least one plasticizer. In particular, the second isocyanate reactive component includes from 30 wt % to 49 wt % (e.g., 30 wt % to 49 wt %, 35 wt % to 49 wt %, 35 wt % to 45 wt %, etc.) of at least one polyoxypropylene-polyoxyethylene polyether polyol based on a total weight of the second isocyanate reactive component. By polyoxypropylene-polyoxyethylene polyether polyol it is meant a polyether polyol derived from a minority of ethylene oxide and a majority of propylene oxide.

The at least one polyoxypropylene-polyoxyethylene polyether polyol has an ethylene oxide content from 10% to 30% (e.g., 10% to 20%, 15% to 17%, etc.) based on a total alkylene oxide content of the at least one polyoxypropylene-polyoxyethylene polyether polyol. The at least one polyoxypropylene-polyoxyethylene polyether polyol has a nominal hydroxyl functionality from 2 to 4 (e.g., is a diol or triol). The at least one polyoxypropylene-polyoxyethylene polyether polyol has a hydroxyl number from 20 mg KOH/g to 40 mg KOH/g (e.g., from 25 mg KOH/g to 35 mg KOH/g, etc.). The at least one polyoxypropylene-polyoxyethylene polyether polyol has a primary hydroxyl content of at least 40% (e.g., from 50% to 99%, from 60% to 98%, from 70% to 98%, from 80% to 95%, from 85% to 95%, etc.) based on a total hydroxyl content of the at least one polyoxypropylene-polyoxyethylene polyether polyol.

The least one polyoxypropylene-polyoxyethylene polyether polyol may include (e.g., consists essentially of) a first polyoxypropylene-polyoxyethylene polyether polyol that has a primary hydroxyl content from 80% to 95%.

The second isocyanate reactive component may further include from 1 wt % to 5 wt % of at least one second polyoxypropylene polyether polyol based on a total weight of the second isocyanate reactive component. By polyoxypropylene polyether polyol it is meant a homopolymer such that the polyether polyol is derived from propylene oxide. The at least one polyoxypropylene polyether polyol may have a nominal hydroxyl functionality from 2 to 4 (e.g., tetrol). The at least one polyoxypropylene polyether polyol has a hydroxyl number from 600 mg KOH/g to 900 mg KOH/g (e.g., 750 mg KOH/g to 850 mg KOH/g, 775 mg KOH/g to 825 mg KOH/g, etc.)

The second isocyanate reactive component includes from 51 wt % to 70 wt % (e.g., 51 wt % to 60 wt %, etc.) of at least one acetylated ester based plasticizer based on a total weight of the second isocyanate reactive component. By acetylated ester it meant an ester compound that further contains at least one added acetyl group. For example, the acetylated ester based plasticizer may be an acetylated citrate based plasticizer. In exemplary embodiments, the acetylated ester based plasticizer is acetyltributyl citrate. The second isocyanate compound may further include from 40 wt % to 60 wt % (e.g., 45 wt % to 55 wt %, etc.) of at least one acetylated ester based plasticizer based on a total weight of the second isocyanate component,

### EXAMPLES

The following examples are provided to illustrate the embodiments of the invention, but are not intended to limit the scope thereof. All parts and percentages are by weight unless otherwise indicated.

The data and descriptive information provided herein are based on approximations. Further, the materials principally used are as the following:

| | |
|---|---|
| Polyol 1 | A polyoxypropylene polyether polyol, having |
| | approximately a nominal hydroxyl functionality |
| | of 3 and a hydroxyl number of 166 mg KOH/g |
| | (available from The Dow Chemical Company). |
| Polyol 2 | A polyoxyethylene-polyoxypropylene polyether |
| | polyol, having approximately an ethylene oxide |
| | content of approximately 78 wt % (with remainder |
| | propylene oxide), a nominal hydroxyl functionality |
| | of 3, primary hydroxyl content of approximately |
| | 92%, and a hydroxyl number of 37 mg KOH/g |
| | (available from The Dow Chemical Company). |
| Polyol 3 | A polyoxyethylene-polyoxypropylene polyether |
| | polyol, having approximately an ethylene oxide |
| | content of approximately 78 wt % (with remainder |
| | propylene oxide), a nominal hydroxyl functionality |
| | of 3, primary hydroxyl content of approximately |
| | 43%, and a hydroxyl number of 34 mg KOH/g |
| | (available from The Dow Chemical Company). |
| Polyol 4 | A polyoxypropylene polyether polyol, having |
| | approximately a nominal hydroxyl functionality of |
| | 2 and a hydroxyl number of 56 mg KOH/g |
| | (available from The Dow Chemical Company). |
| Polyol 5 | A polyoxypropylene-polyoxyethylene polyether |
| | polyol, having approximately an ethylene oxide |
| | content of approximately 17 wt % (with remainder |
| | propylene oxide), a nominal hydroxyl functionality |
| | of 2, primary hydroxyl content of approximately |
| | 91%, and a hydroxyl number of 29 mg KOH/g |
| | (available from The Dow Chemical Company). |
| Polyol 6 | A polyoxypropylene polyether polyol, having |
| | approximately a nominal hydroxyl functionality |
| | of 4 and a hydroxyl number of 798 mg KOH/g |
| | (available from The Dow Chemical Company). |
| Polyol 7 | A polyoxypropylene polyether polyol, having |
| | approximately a nominal hydroxyl functionality |
| | of 2 and a hydroxyl number of 56 mg KOH/g |
| | (available from The Dow Chemical Company). |
| Isocyanate 1 | A methylene diphenyl diisocyanate - MDI having |
| | approximately at least 98% of 4,4′ - MDI content |
| | (available from The Dow Chemical Company). |
| Isocyanate 2 | A polymeric methylene diphenyl diisocyanate - |
| | PMDI having approximate NCO content of 32.7% |
| | (available from The Dow Chemical Company). |
| Isocyanate 3 | An isocyanate terminated prepolymer having an |
| | NCO content of ~5% and including approximately |
| | 50 pbw of the Plasticizer, the prepolymer being the |
| | reaction product of approximately 19 pbw of |
| | Isocyanate 1 and 31 pbw of Polyol 7, in the |
| | presence of benzoyl chloride (available from The |
| | Dow Chemical Company). |
| Catalyst 1 | A catalyst (available as JEFFCAT ® ZF-10 from |
| | Huntsman). |
| Catalyst 2 | A catalyst (available as Polycat ® 15 from Evonik |
| | Industries). |
| Surfactant 1 | An organosilicone surfactant (available as Niax ™ |
| | L-417 from Momentive Performance Materials). |
| Surfactant 2 | An organosilicone surfactant (available as Niax ™ |
| | L-595 from Momentive Performance Materials). |
| Plasticizer | Acetyltributyl citrate (available from Wego |
| | Chemical). |
| Additives | A bismuth/zinc neodecanoate mixture and a |
| | polydimethylsiloxane based antifoam agent |
| | (available from Shepherd Chemical Company). |

The polyurethane foam layer and the polyurethane gel layer are prepared according to the formulations in Table 1, below. The polyurethane gel layer is prepared in a specialized mold to provide the desired shape. The isocyanate-reactive and isocyanate-component for the gel forming reaction mixture are mixed using a mixer at high rotation speed for 5 seconds. Then, the mixed gel forming reaction mixture is poured into the specialized mold and after the gel layer is formed the resultant gel layer is demolded. Thereafter, the polyurethane foam layer is formed in a separate foaming mold in which the resultant polyurethane gel layer is placed. The polyurethane foam layer is prepared with the foaming mold temperature set at 135° F. (57° C.) and pre-coated with a releasing agent. The isocyanate-reactive and isocyanate-component for the foam forming reaction mixture are mixed using the 16-pin mixer at high rotation speed for 5 seconds at 2800 rpm. Then, the mixed foam forming reaction mixture is poured into the foaming mold, in which the gel layer is placed on the bottom prior to pouring the foam forming reaction mix therewithin. Then, the foaming mold is degassed and the resultant combined foam and gel layers are demolded. The resultant product is further allowed to cure at least overnight before properties are tested.

TABLE 1

| | | | | | |
|---|---|---|---|---|---|
| Ex. 1 | Ex. 2 | Ex. 3 | Ex. 4 | Ex. A | Ex. B |

FOAM LAYER
Isocyanate-Reactive Component (amount based on parts by weight)

| | | | | | | |
|---|---|---|---|---|---|---|
| Polyol 1 | 5.0 | 5.0 | 5.0 | 5.0 | 5.0 | 5.0 |
| Polyol 2 | 40.0 | 32.0 | 24.0 | — | 80.0 | 63.0 |
| Polyol 3 | 40.0 | 48.0 | 56.0 | 80.0 | — | 17.0 |
| Polyol 4 | 15.0 | 15.0 | 15.0 | 15.0 | 15.0 | 15.0 |
| Water | 6.5 | 6.5 | 6.5 | 6.5 | 6.5 | 6.5 |
| Surfactant 1 | 1.0 | 10 | 1.0 | 1.0 | 1.0 | 1.0 |
| Surfactant 2 | 0.4 | 0.4 | 0.4 | 0.4 | 0.4 | 0.4 |
| Catalyst 1 | <0.1 | <0.1 | <0.1 | <0.1 | <0.1 | <0.1 |
| Catalyst 2 | 0.3 | 0.3 | 0.3 | 0.3 | 0.3 | 0.3 |

Isocyanate Component (amount based on parts by weight)

| | | | | | | |
|---|---|---|---|---|---|---|
| Isocyanate 2 | 54.0 | 54.0 | 54.0 | 54.0 | 54.0 | 54.0 |

Foam Composition Properties

| | | | | | | |
|---|---|---|---|---|---|---|
| Index | 52 | 52 | 52 | 52 | 52 | 52 |

Foam Properties

| | | | | | | |
|---|---|---|---|---|---|---|
| Air Flow (m³/h) | 0.2 | 0.2 | 0.3 | 0.2 | 0.3 | 0.3 |
| Average Resiliency (%) | 5 | 5 | 6 | 6 | 6 | 6 |

GEL LAYER
Isocyanate-Reactive Component (amount based on parts by weight)

| | | | | | | |
|---|---|---|---|---|---|---|
| Polyol 5 | 39.2 | 39.2 | 39.2 | 39.2 | 39.2 | 39.2 |
| Polyol 6 | 1.5 | 1.5 | 1.5 | 1.5 | 1.5 | 1.5 |
| Plasticizer | 58.6 | 58.6 | 58.6 | 58.6 | 58.6 | 58.6 |
| Additives | <0.1 | <0.1 | <0.1 | <0.1 | <0.1 | <0.1 |

Isocyanate Component (amount based on parts by weight)

| | | | | | | |
|---|---|---|---|---|---|---|
| Isocyanate 3 | 24.8 | 24.8 | 24.8 | 24.8 | 24.8 | 24.8 |

Gel Composition Properties

| | | | | | | |
|---|---|---|---|---|---|---|
| Index | 73 | 73 | 73 | 73 | 73 | 73 |

Adhesion Properties between Foam layer and Gel layer

| | | | | | | |
|---|---|---|---|---|---|---|
| Delamination visually | No | No | No | No | Yes | Yes |
| observed? | | | | | | |
| Detachment Area (m²) | — | — | — | — | 0.1 | 0.1 |

Referring to the Table 1, above, it is shown that with use of the specified formulated system for the foam layer and the specified formulated system for the gel layer, improved adhesion properties are observed between the two layers.

With respect to the data in Table 1, delamination is visually observed as yes or no. When delamination is observed, the detachment area is measured using paper. In particular, the paper is cut using scissor around the edge of the foam layer-gel layer detachment area. Then, the paper is weighed, and the delamination area calculated based on the weight of the cut-out paper.

The foam layer is tested for airflow and resilience according to ASTM D-3574.

While the foregoing is directed to exemplary embodiments, other and further embodiments may be devised without departing from the basic scope thereof, and the scope thereof is determined by the claims that follow.

1. A coated viscoelastic polyurethane foam, comprising:
a viscoelastic polyurethane foam that is a reaction product of a first isocyanate component and a first isocyanate reactive component, the first isocyanate component including at least one polyisocyanate, and the first isocyanate reactive component having a first polyol component including:
(i) from 60 wt % to 90 wt % of at least one polyoxyethylene-polyoxypropylene polyether polyol based on a total weight of the first polyol component, the at least one polyoxyethylene-polyoxypropylene polyether polyol having an ethylene oxide content of at least 50% based on a total alkylene oxide content of the at least one polyoxyethylene-polyoxypropylene polyether polyol, a nominal hydroxyl functionality from 2 to 4, a hydroxyl number from 25 mg KOH/g to 45 mg KOH/g, and a primary hydroxyl content of at least 40% based on a total hydroxyl content of the at least one polyoxyethylene-polyoxypropylene polyether polyol, and
(ii) from 10 wt % to 40 wt % of at least one polyoxypropylene polyether polyol based on the total weight of the first polyol component, the at least one polyoxypropylene polyether polyol having a nominal hydroxyl functionality from 2 to 4 and a hydroxyl number from 40 mg KOH/g to 200 mg KOH/g; and
a coating material on the viscoelastic polyurethane foam, the coating material being a reaction product of a second isocyanate component and a second isocyanate reactive component, the second isocyanate component including at least one isocyanate-terminated prepolymer, and the second isocyanate reactive component including:
(iii) from 30 wt % to 49 wt % of at least one polyoxypropylene-polyoxyethylene polyether polyol based on a total weight of the second isocyanate reactive component, the at least one polyoxypropylene-polyoxyethylene polyether polyol having an ethylene oxide content from 10% to 30% based on a total alkylene oxide content of the at least one polyoxypropylene-polyoxyethylene polyether polyol, a nominal hydroxyl functionality from 2 to 4, a hydroxyl number from 20 mg KOH/g to 40 mg KOH/g, and a primary hydroxyl content of at least 40% based on a total hydroxyl content of the at least one polyoxypropylene-polyoxyethylene polyether polyol, and
(iv) from 51 wt % to 70 wt % of at least one acetylated ester based plasticizer based on a total weight of the second isocyanate reactive component.

2. The coated viscoelastic polyurethane foam as claimed in claim 1, wherein the at least one acetylated polyester plasticizer is an acetylated citrate based plasticizer.

3. The coated viscoelastic polyurethane foam as claimed in claim 1, wherein the second isocyanate component further includes from 40 wt % to 60 wt % of the at least one acetylated ester based plasticizer based on a total weight of the second isocyanate component.

4. The coated viscoelastic polyurethane foam as claimed in claim 1, wherein:
the at least one polyoxyethylene-polyoxypropylene polyether polyol of the first isocyanate reactive component includes a first polyoxyethylene-polyoxypropylene polyether polyol having the ethylene content from 70% to 85%, the primary hydroxyl content from 40% to 50%, and the hydroxyl number from 30 mg KOH/g to 40 mg KOH/g; and
the at least one polyoxypropylene-polyoxyethylene polyether polyol of the second isocyanate reactive component includes a first polyoxypropylene-polyoxyethylene polyether polyol having the primary hydroxyl content from 80% to 95%.

5. The coated viscoelastic polyurethane foam as claimed in claim 4, wherein:
the first polyol component consists essentially of the at least one polyoxypropylene polyether polyol and the at least one polyoxyethylene-polyoxypropylene polyether polyol including the first polyoxyethylene-polyoxypropylene polyether polyol and optionally a second polyoxyethylene-polyoxypropylene polyether polyol different from the first polyoxyethylene-polyoxypropylene polyether polyol; and
the at least one polyoxypropylene-polyoxyethylene polyether polyol of the second isocyanate reactive component consists essentially of the first polyoxypropylene-polyoxyethylene polyether polyol.

6. The coated viscoelastic polyurethane foam as claimed in claim 1, wherein the viscoelastic polyurethane foam has a first isocyanate index from 40 to 150 and the coating material has a second isocyanate index from 60 to 90.

7. The coated viscoelastic polyurethane foam as claimed in claim 1, wherein the at least one isocyanate-terminated prepolymer of the second isocyanate component is a reaction product of a second polyisocyanate and a second polyoxypropylene polyether polyol having a nominal hydroxyl functionality from 2 to 4 and a hydroxyl number from 45 mg KOH/g to 65 mg KOH/g.

8. The coated viscoelastic polyurethane foam as claimed in claim 1, wherein the viscoelastic polyurethane foam is directly on the coating material.

9. A method of making the coated viscoelastic polyurethane foam as claimed in claim 1, the method comprising preparing the coating material and preparing the viscoelastic polyurethane foam.
